(19) United States
(12) Patent Application Publication
(10) Pub. No.: US 2005/0031235 A1
(43) Pub. Date: Feb. 10, 2005

(54) One piece thrust-plate/shaft assembly for hydrodynamic bearing

(75) Inventor: Ronald Goenner, Geisingen (DE)

Correspondence Address: SCHULTE ROTH & ZABEL LLP;ATTN: JOEL E. LUTZKER, 919 THIRD AVENUE, NEW YORK, NY, 10022, US

(73) Assignee: Minebea Co., Ltd., Nagano-Ken (JP)

(21) Appl. No.: 10/634,007

(22) Filed: Aug. 4, 2003

(51) Int. Cl. F16C 32/06

(52) U.S. Cl. 384/107

(57) ABSTRACT

A hydrodynamic bearing system, having a one-piece thrust-plate/shaft component, which includes a shaft portion and a thrust plate portion. The one-piece thrust-plate/shaft component is formed by powder injection molding process.

### FIELD OF THE INVENTION

The following application relates to the field of spindle motors and more specifically to a design that allows for more efficient manufacture of such motors.

### BACKGROUND OF THE INVENTION

Disk drive systems have been used in computers and other electronic devices for many years for storage of digital information. Information is recorded on concentric memory tracks of a magnetic disk medium, the actual information being stored in the form of magnetic transitions within the medium. The disks themselves are rotatably mounted on a shaft or “spindle”, the information being accessed by means of transducers located on a pivoting arm, which moves radially over the surface of the disk. The read/write heads or transducers must be accurately aligned with the storage tracks on the disk to ensure proper reading and writing of information; thus the disks must be rotationally stable.

Electric spindle motors are used to rotate the discs in disk drive systems. Such spindle motors may have either a fixed shaft and a rotating sleeve or a fixed sleeve and a rotating shaft. An example of a currently known spindle motor for use in hard disk drive systems is shown in FIG. 6. Spindle motor 110 comprises a rotor portion and a stator portion. In the prior art example of FIG. 6, the rotor portion includes rotating shaft 112 with hub 111 secured to the top of the shaft. A magnetic disk (not shown) may be secured to the top of hub 111 for rotation with the shaft. Permanent magnet 117 is secured to the yoke portion 127 of hub 111. The stator portion comprises frame 119 and sleeve 113 mounted on the frame such that rotating shaft 112 is inserted into the sleeve for rotation. Stator core 116 with winding 115 is secured to an outer surface of the tubular extension of frame 119 such that the stator core is placed in an opposing relationship with permanent magnet 117 of the rotor portion. A plurality of radial pressure-generating grooves 118 is provided on the outer surface of rotating shaft 112. A lubricant is injected into a bearing gap formed between the outer surface of rotating shaft and the inner surface of the sleeve. During operation of the spindle motor, grooves 118 generate hydrodynamic pressure gradients in the lubricant resulting in a radial force allowing the shaft to rotate inside the sleeve in a suspended state without touching inner walls of the sleeve.

Thrust plate 114 is secured to the bottom end of shaft 112. Thrust pressure-generating grooves (not shown) may be provided on the bottom or the top surface of the thrust plate. During operation, thrust pressure-generating grooves generate axial pressure gradients allowing the shaft to be suspended in the axial direction. In accordance with the current state of the art, thrust plate 114 is press-fit to the bottom of shaft 112. In order to accomplish desired functionality of the spindle motor, parameters of the pressing process have to be carefully observed. Press-fit force has to be carefully calculated and a strict perpendicularity should be accomplished between the thrust plate and the shaft. This result is difficult to achieve by the currently existing thrust plate pressing process.

Newer designs of spindle motors with hydrodynamic bearings utilize very thin thrust plates. The problem of calculating a proper press-fit force and accomplishing perpendicularity between elements is even more difficult to solve in a spindle motor having a very thin thrust plate. Such thin thrust plates can be easily bent or simply misaligned with other elements of the motor during the pressing process.

Other new designs of spindle motors with hydrodynamic bearings incorporate a thrust plate positioned in the midsection of the shaft. In these designs, when the thrust plate is press fit onto the shaft, it is particularly difficult to calculate a proper pressing force for pressing the thrust plate to achieve the desired perpendicularity and concentricity. The process is further complicated when additional elements have to be assembled into the hydrodynamic bearing system. For example, if the thrust plate was press fit in the system shown in FIG. 5, its concentricity and perpendicularity would have to be first adjusted when it is placed onto the shaft, then further adjusted when the shaft is press fit into the frame, and then there is a risk of moving the thrust plate out of this proper position when the hub is placed onto the shaft. Thus, the manufacturing cost of the spindle motor is tremendously increased.

Thus, there is a need in the art for a thrust plate manufacturing process allowing for its easy positioning on the shaft and simplified assembly into the hydrodynamic bearing.

### SUMMARY

In accordance with one aspect of the present invention, a hydrodynamic bearing system is provided having a one-piece thrust-plate/shaft component, which includes a shaft portion and a thrust plate portion. The one-piece thrust-plate/shaft component is formed by powder injection molding process.

In accordance with another aspect of the present invention, a spindle motor is provided having a hydrodynamic bearing system with a one-piece thrust-plate/shaft component, which includes a shaft portion and a thrust plate portion. The one-piece thrust-plate/shaft component is formed by powder injection molding process.

In accordance with a further aspect of the present invention, a method of manufacturing a hydrodynamic bearing system is provided. The method is accomplished by crushing raw steel material into fine powder, mixing and kneading a binder with the fine powder, and then pressure injection molding a one-piece thrust-plate/shaft component having a thrust plate portion and a shaft portion. The resulting one-piece thrust-plate/shaft component is ground and lopped to achieve desired characteristics of the thrust plate portion and the shaft portion. The ground and lopped one-piece thrust-plate/shaft component is then assembled into the hydrodynamic bearing system without destroying the achieved desired characteristics.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a side view of the one-piece thrust-plate/shaft component wherein the thrust-pate is formed at the end of the shaft.

FIG. 2 is a side view of the one-piece thrust-plate/shaft component wherein the thrust-pate is very thin and is formed at the end of the shaft.

FIG. 3 is a side view of the one-piece thrust-plate/shaft component wherein the thrust-pate is formed in the midsection of the shaft.

FIG. 4 is a cross-sectional view of the spindle motor having a hydrodynamic bearing assembly with one-piece thrust-plate/shaft component wherein the thrust-pate is formed at the end of the shaft.

FIG. 5 is a cross-sectional view of the spindle motor having a hydrodynamic bearing assembly with one-piece thrust-plate/shaft component wherein the thrust-pate is formed in the midsection of the shaft.

FIG. 6 is a cross-sectional view of a spindle motor having a conventionally manufactured thrust-plate assembly.

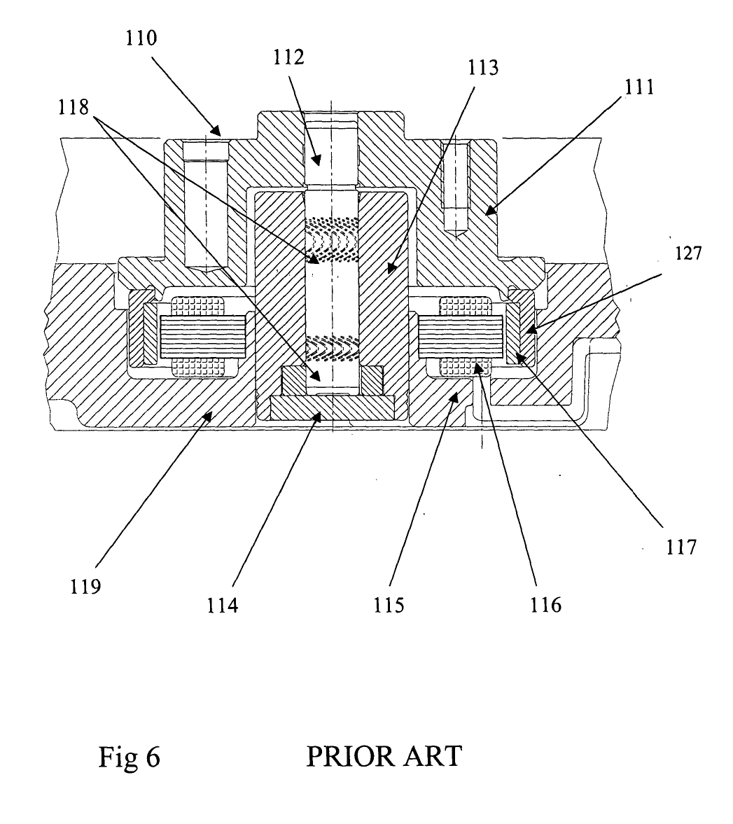

### DETAILED DESCRIPTION OF THE PREFERRED EMBODIMENT

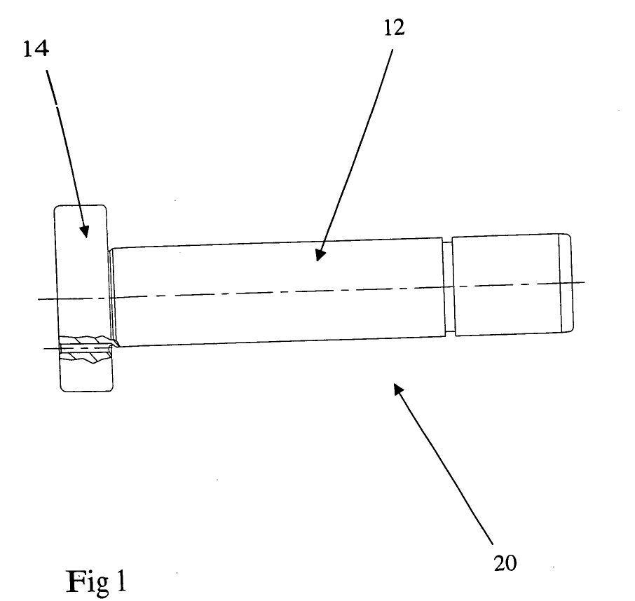

As shown in FIG. 1, in accordance with the present invention, thrust-plate 14 and shaft 12 are formed as one-piece component 20. Unitary thrust-plate/shaft component 20 is formed by powder injection molding process. The powder injection molding process is preferably performed by crushing raw steel material into fine powder, mixing a binder with the fine powder and then kneading them together. The resulting material is then heated, melted and pressure injection molded and casted in a die having a shape of the shaft with the thrust plate. Burning of the cast is then performed to obtain the unitary thrust-plate/shaft component in its “near net shape” form. To insure the concentricity and perpendicularity of unitary component 20, its elements are ground and lopped in a single common process, thus eliminating the need for any additional steps.

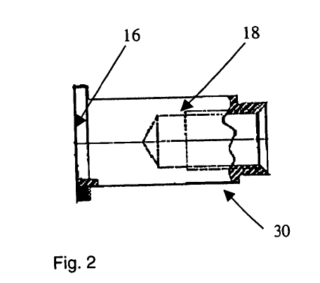

The above described powder injection molding process may be further utilized to form a thin thrust plate/shaft component 30, shown in FIG. 2. Similarly to the above, thin thrust plate 16 and shaft 18 are formed as a one-piece component by a powder injection molding process. Perpendicularity and concentricity of elements of one-piece component 30 is achieved by grinding and lopping the one-piece component and thus is not likely to be changed during assembly of the hydrodynamic bearing.

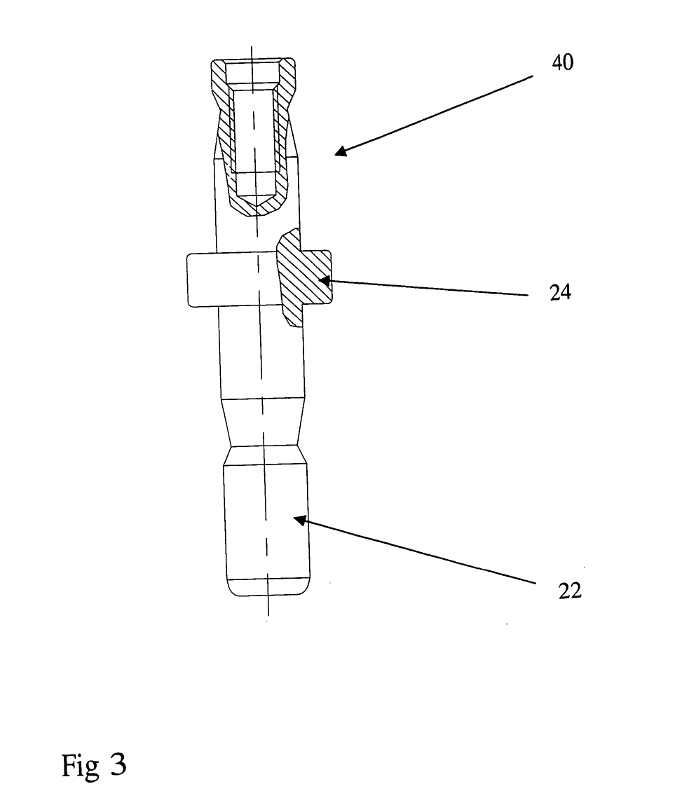

A further embodiment of the present invention is shown in FIG. 3. One-piece thrust-plate/shaft component 40 includes shaft 22 and a thrust plate 24. Thrust plate 24 is positioned in the midsection of shaft 22. As will be appreciated by a person skilled in the art, thrust plate 24 may be formed anywhere along shaft 22 and not just in the midsection. One-piece thrust-plate/shaft component 40 is formed by powder injection molding process. Similarly to the first described embodiment, the powder injection molding process is preferably performed by crushing raw steel material into fine powder, mixing a binder with the fine powder and then kneading them together. The resulting material is then heated, melted and pressure injection molded and casted in a die having a shape of shaft 22 having thrust plate 24 in its midsection. Burning of the cast is then performed to obtain the one-piece thrust-plate/shaft component in its “near net shape” form. To insure the concentricity and perpendicularity of unitary component 40, its elements are ground and lopped in a single common process, thus eliminating the need for any additional steps. Achieved concentricity and perpendicularity is not destroyed during the assembly of the hydrodynamic bearing because there is no possibility of relative movement between shaft 22 and thrust plate 24. Forming thrust plate 24 as a unitary component with shaft 22 has an additional advantage of avoiding surface damage to the shaft which is possible during a thrust plate pressing process.

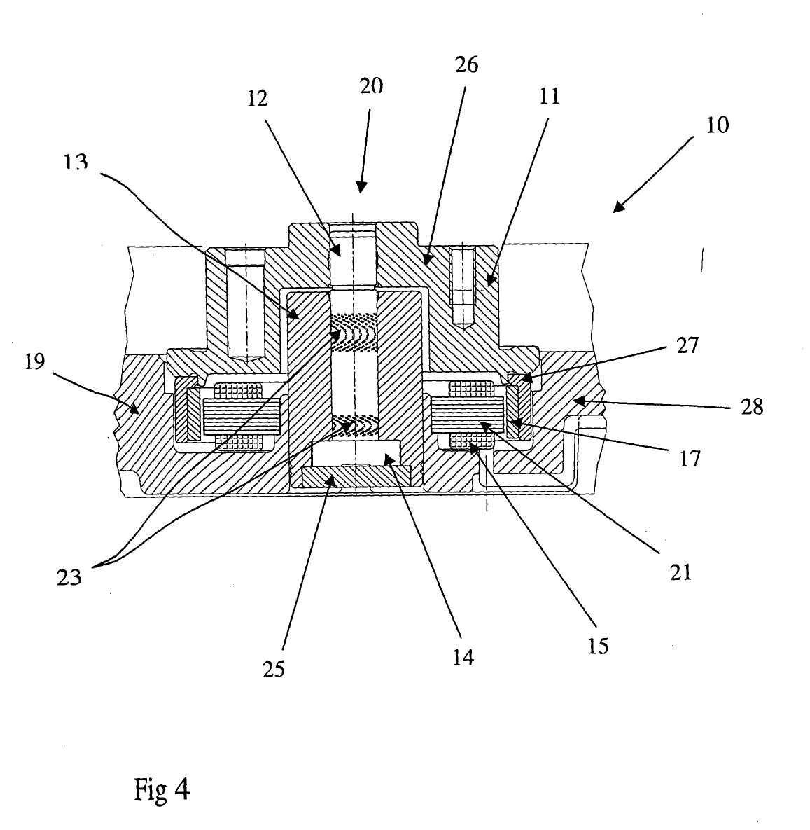

A spindle motor having a hydrodynamic bearing with a one-piece thrust-plate/shaft component is shown in FIG. 4. In the embodiment shown in FIG. 4, spindle motor 10 comprises rotor portion 26 and stator portion 28. Rotor portion 26 includes rotating one-piece thrust-plate/shaft component 20 having shaft portion 12 and thrust plate portion 14. Hub 11 is secured to the top of shaft portion 12 of the rotating one-piece component. A magnetic disk (not shown) may be secured to the top of hub 11 for rotation with the shaft. Yoke portion 27 is secured to the lower end of hub 11. Permanent magnet 17 is secured to the yoke portion of hub 11. Stator portion 28 comprises frame 19 and sleeve 13 mounted on the frame such that rotating one-piece thrust-pate/shaft component 20 is inserted into the sleeve for rotation. Bottom opening of the sleeve is sealed with a counter plate 25. Stator core 21 with winding 15 is secured to the outer surface of sleeve 13 such that the stator core is placed in an opposing relationship with permanent magnet 17 of the rotor portion. A plurality of radial pressure-generating grooves 23 is provided on the outer surface of shaft portion 12. A lubricant is filled into a bearing gap formed between the outer surface of rotating one-piece thrust-plate/shaft component 20 and the inner surface of the sleeve. During operation of the spindle motor, grooves 23 generate hydrodynamic pressure gradients in the lubricant resulting in a radial force allowing the one-piece thrust-plate/shaft component to rotate inside the sleeve in a suspended state without touching inner walls of the sleeve.

In the preferred embodiment shown in FIG. 4, thrust plate portion 14 is formed at the bottom end of shaft portion 12. Thrust pressure-generating grooves (not shown) may be provided on the bottom and/or the top surface of the thrust plate. Thrust pressure-generating grooves may also be provided on the top surface of counter plate 25. During operation, thrust pressure-generating grooves generate axial pressure gradients in the lubricant allowing the one-piece thrust-plate/shaft component to be suspended in the axial direction.

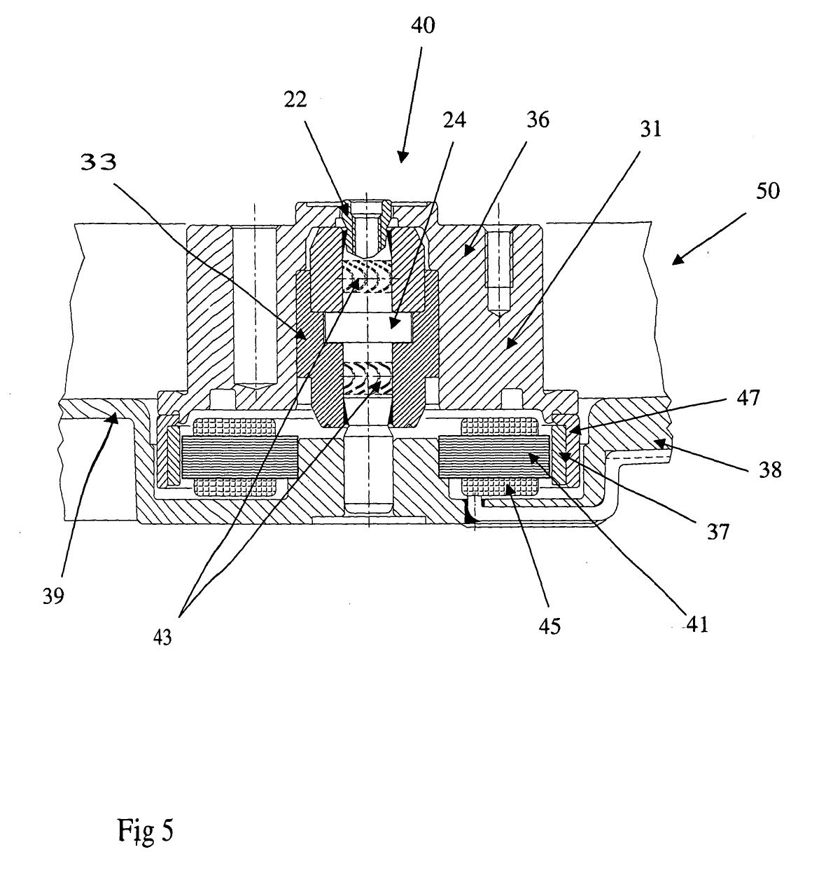

Another embodiment of a spindle motor having a hydrodynamic bearing with a one-piece thrust-plate/shaft component is shown in FIG. 5. In the embodiment shown in FIG. 5, spindle motor 50 comprises rotor portion 36 and stator portion 38. Rotor portion 36 includes hub 31 having bushing 33 secured within an inner cavity of hub 31. A magnetic disk (not shown) may be secured to the top of hub 31 for rotation with the hub. Yoke portion 47 is mounted to the lower end of hub 31. Permanent magnet 37 is secured to the yoke portion of hub 31. Stator portion 38 comprises frame 39 and fixed one-piece thrust-plate/shaft component 40 mounted on the frame such that fixed one-piece thrust-plate/shaft component 40 is inserted into a cylindrical bore of bushing 33. Fixed one-piece thrust-plate/shaft component 40 includes shaft portion 22 and thrust plate portion 24. Shaft portion 22 is secured at its bottom end to frame 39 and its top end to a top cover (not shown). Thrust plate portion 24 is secured between an upper and lower portions of bushing 33. Stator core 41 with winding 45 is secured to frame 39 such that the stator core is placed in an opposing relationship with permanent magnet 37 of the rotor portion. A plurality of radial pressure-generating grooves 43 is provided on the outer surface of shaft portion 22. A lubricant is filled into a bearing gap formed between the outer surface of fixed one-piece thrust-plate/shaft component 40 and the inner surface of the sleeve. During operation of the spindle motor, grooves 43 generate hydrodynamic pressure gradients in the lubricant resulting in a radial force allowing the hub with the bushing to rotate around the one-piece thrust-plate/shaft component in a suspended state without touching outer surfaces of one-piece component 40.

In the preferred embodiment shown in FIG. 5, thrust plate portion 24 is formed in the midsection of shaft portion 22. Thrust pressure-generating grooves (not shown) may be provided on the bottom and/or the top surface of the thrust plate. Thrust pressure-generating grooves may also be provided on surfaces of the upper and lower portions of bushing 33 opposing to the surfaces of the thrust plate portion. During operation, thrust pressure-generating grooves generate axial pressure gradients in the lubricant allowing the bushing to be suspended in the axial direction.

In order to assemble the hydrodynamic bearing system of FIG. 5, the lower portion of bushing 33 is first placed onto shaft portion 22 of one-piece thrust-plate/shaft component 40 below thrust plate portion 24. The upper portion of bushing 33 is placed onto shaft portion 22 of one-piece thrust-plate/shaft component 40 above thrust plate portion 24. Than the hydrodynamic bearing system is filled with lubricating oil, placed into and secured to the center bore of hub 31. Finally rotor portion 36 is assembled to frame 39 by securing the lower end of the shaft component to frame 39. During the assembly, there is no risk that perpendicularity and concentricity between the thrust plate portion and the shaft portion would be destroyed because there is no relative movement between the portions of one-piece thrust-plate/shaft component.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

1. A hydrodynamic bearing system, comprising:
a one-piece thrust-plate/shaft component, further comprising a shaft portion and a thrust plate portion,
wherein said one-piece thrust-plate/shaft component is formed by powder injection molding process.

2. The hydrodynamic bearing system according to claim 1 further comprising a sleeve, said sleeve having a cylindrical inner bore, wherein said one-piece thrust-plate/shaft component is positioned within said cylindrical inner bore of said sleeve.

3. The hydrodynamic bearing system according to claim 1, wherein said thrust plate portion of said one-piece thrust-plate/shaft component is positioned at a bottom end of said shaft portion.

4. The hydrodynamic bearing system according to claim 3, wherein said thrust plate portion of said one-piece thrust-plate/shaft component is a thin thrust plate.

5. The hydrodynamic bearing system according to claim 1, wherein said thrust plate portion of said one-piece thrust-plate/shaft component is positioned at a midsection of said shaft portion.

6. The hydrodynamic bearing system according to claim 1, wherein said one-piece thrust-plate/shaft component is a rotating element of said hydrodynamic bearing system.

7. The hydrodynamic bearing system according to claim 1, wherein said one-piece thrust-plate/shaft component is a fixed element of said hydrodynamic bearing system.

8. A spindle motor with a hydrodynamic bearing system, comprising:
a one-piece thrust-plate/shaft component, further comprising a shaft portion and a thrust plate portion,
wherein said one-piece thrust-plate/shaft component is formed by powder injection molding process.

9. The spindle motor according to claim 8 further comprising a sleeve, said sleeve having a cylindrical inner bore, wherein said one-piece thrust-plate/shaft component is positioned within said cylindrical inner bore of said sleeve.

10. The spindle motor according to claim 8, wherein said thrust plate portion of said one-piece thrust-plate/shaft component is positioned at a bottom end of said shaft portion.

11. The spindle motor according to claim 10, wherein said thrust plate portion of said one-piece thrust-plate/shaft component is a thin thrust plate.

12. The spindle motor according to claim 8, wherein said thrust plate portion of said one-piece thrust-plate/shaft component is positioned at a midsection of said shaft portion.

13. The spindle motor according to claim 8, wherein said one-piece thrust-plate/shaft component is a rotating element of said hydrodynamic bearing system.

14. The spindle motor according to claim 8, wherein said one-piece thrust-plate/shaft component is a fixed element of said hydrodynamic bearing system.

15. A method of manufacturing a hydrodynamic bearing system, comprising the steps of:
crushing raw steel material into fine powder;
mixing and kneading a binder with the fine powder;
pressure injection molding a one-piece thrust-plate/shaft component having a thrust plate portion and a shaft portion;
grinding and lopping said one-piece thrust-plate/shaft component to achieve desired characteristics of said thrust plate portion and said shaft portion; and
assembling said one-piece thrust-plate/shaft component into said hydrodynamic bearing system without destroying said achieved desired characteristics.

16. The method of manufacturing a hydrodynamic bearing system according to claim 15, wherein said desired characteristic is perpendicularity.

17. The method of manufacturing a hydrodynamic bearing system according to claim 15, wherein said desired characteristic is concentricity.
